(19) United States
(12) Patent Application Publication
(10) Pub. No.: US 2013/0029299 A1
(43) Pub. Date: Jan. 31, 2013

(54) REVERSIBLE LANGUAGE LEARNING SYSTEM

(71) Applicant: Harry A. Layman, Reston, VA (US)

(72) Inventor: Harry A. Layman, Reston, VA (US)

(21) Appl. No.: 13/190,695

(22) Filed: Jul. 26, 2011

(51) Int. Cl. G09B 19/06

(52) U.S. Cl. 434/157

(57) ABSTRACT

A reversible written language learning system uses sets of related words, where each word in the set is represented in a first and second language and has an associated picture. Each word and picture is displayed on its own tile. Some tiles displaying words in one language or associated pictures are displayed in a grid. Corresponding tiles having words in the other language or associated pictures are kept apart from the grid and displayed one at a time as tiles to be matched. A user matches the tile to be matched with a corresponding tile in the grid. Upon a successful match, the grid tile selected is flipped over or grayed out, and a new tile to be matched is displayed. The tiles in the grid and the tiles kept apart are easily swapped. The system lends itself to any language pair, but particularly to Sino-Tibetan/Indo-European language pairs.

### BACKGROUND

1. Field of the Invention

The present invention relates generally to language learning systems, and more particularly to computer-aided written language learning.

2. Description of Related Art

Second language acquisition is a well-studied and difficult problem, with many common approaches appropriate to various language pairs. Among the most difficult of L1:L2 language-learning problems is the acquisition of Sino-Tibetan languages by speakers of Indo-European languages. In these cases, the differences in writing systems is a particular challenge, separate and apart from other potential issues (e.g. tonal vs. a-tonal languages), and in particular many English speakers make progress on understanding and speaking Chinese far more rapidly than they learn to read and write the language.

Needs therefore exist for improved systems, learning devices and software for assisting students in learning a foreign language, and particularly for assisting speakers of Indo-European languages in learning the writing systems of Sino-Tibetan languages.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. In certain embodiments, the disclosed embodiments may include one or more of the features described herein.

In accordance to an embodiment of the invention, a novel instructional design and learning system for students of foreign language is provided.

A new system includes a processor and a memory containing a program, which, when executed by the processor, is configured to perform an operation. The operation includes: displaying a first half of a set of tiles, the first half including words in a first language and pictures representing the words in the first language, indicating a tile to be matched, where the tile to be matched is selected from a second half of the set of tiles, the second half including words in a second language and pictures representing the words in the second language, where each tile in the first half of the set corresponds to a tile in the second half of the set, displaying user options, receiving user input, and determining whether the user input selected a tile from the first set of tiles and if so whether the selected tile corresponds to the tile to be matched and displaying an indication of whether the selection corresponds accordingly, and when the selected tile corresponds to the tile to be matched, indicating another tile from the second half of the set of tiles as the tile to be matched.

The operation may also include displaying an indication that the selected tile has been matched when the selected tile corresponds to the tile to be matched. The words in the set of tiles may be conceptually related. Two or more words in at least one of the first half and the second half of the set of tiles may share Sino-Tibetan characters. The operation may also include replacing the set of tiles from which the displayed tiles are drawn with a second set of tiles, in response to the user input. The operation may also include swapping the first half of the set of tiles and the second half of the set of tiles in response to the user input, such that the second half of the set of tiles is displayed and a first tile from the second half of the set of tiles is displayed, so that the positions of the first and second languages are reversed in the system.

The operation may also include changing the language of displayed instruction text and labels from one language to another in response to the user input. The operation may also include providing a hint as to the correct match for the tile to be matched in response to the user input. The operation may also include calculating a score taking into account one or more factors selected from the following group: time spent, incorrect guesses, and number of hints. The displaying of the first half of the set of tiles may include displaying the first half of the set of tiles in a random order that is independent of the order in which the second half of the set of tiles is displayed. The displaying of the first half of the set of tiles may include displaying the first half of the set of tiles in the same order as the second half of the set of tiles is indicated. The displaying of the first half of the set of tiles may include displaying the first half of the set of tiles in a grid pattern. The operation may also include receiving payment information and downloading a new set of tiles in response to the user input. The operation may also include receiving login information and allowing access to sets of tiles accordingly.

In a new method, a first half of a set of tiles is displayed on a display device, the first half including words in a first language and pictures representing the words in the first language, a tile to be matched is indicated on the display device from a second half of the set of tiles, the second half including words in a second language and pictures representing the words in the second language, where each tile in the first half of the set corresponds to a tile in the second half of the set, user options are displayed on the display device, user input is received via an input device, and it is determined, using a processor, whether the user input selected a tile from the first set of tiles that corresponds or does not correspond to the tile to be matched, an indication of the selection is displayed on the display device accordingly, and when the selected tile corresponds to the tile to be matched, another tile from the second half of the set of tiles is indicated on the display device as the tile to be matched.

When the selected tile corresponds to the tile to be matched, an indication that the selected tile has been matched may be displayed. Two or more words in at least one of the first half and the second half of the set of tiles may share Sino-Tibetan characters. The set of tiles from which the displayed tiles are drawn may be replaced with a second set of tiles, in response to the user input. The first half of the set of tiles and the second half of the set of tiles may be swapped in response to the user input, such that the second half of the set of tiles is displayed and a tile to be matched from the second half of the set of tiles is indicated.

A new computer-readable storage medium includes a program, which when executed on a processor performs an operation, the operation including: displaying a first half of a set of tiles, the first half including words in a first language and pictures representing the words in the first language, indicating a tile to be matched from a second half of the set of tiles, the second half including words in a second language and pictures representing the words in the second language, where each tile in the first half of the set corresponds to a tile in the second half of the set, displaying user options, receiving user input, and determining whether the user input selected a tile from the first set of tiles that corresponds or does not correspond to the tile to be matched and displaying an indication of the selection accordingly, and if the selected tile corresponds to the tile to be matched, indicating as the tile to be matched a second tile from the second half of the set of tiles.

### BRIEF DESCRIPTION OF THE DRAWINGS

The invention may be understood by reference to the following description taken in conjunction with the accompanying drawings, which are incorporated herein and form a part of the specification, and in which:

FIG. 1 shows a block diagram illustrating client and server computers coupled to a network according to one embodiment of the present invention.

FIGS. 2-14 illustrate various features of and show a tablet computer embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

A new reversible language learning system will now be disclosed in terms of various exemplary embodiments. This specification discloses one or more embodiments that incorporate features of the invention. The embodiment(s) described, and references in the specification to “some embodiments”, “one embodiment”, “an embodiment”, “an example embodiment”, etc., indicate that the embodiment(s) described may include a particular feature, structure, or characteristic. Such phrases are not necessarily referring to the same embodiment(s). When a particular feature, structure, or characteristic is described in connection with an embodiment, persons skilled in the art may effect such feature, structure, or characteristic in connection with other embodiments whether or not explicitly described.

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

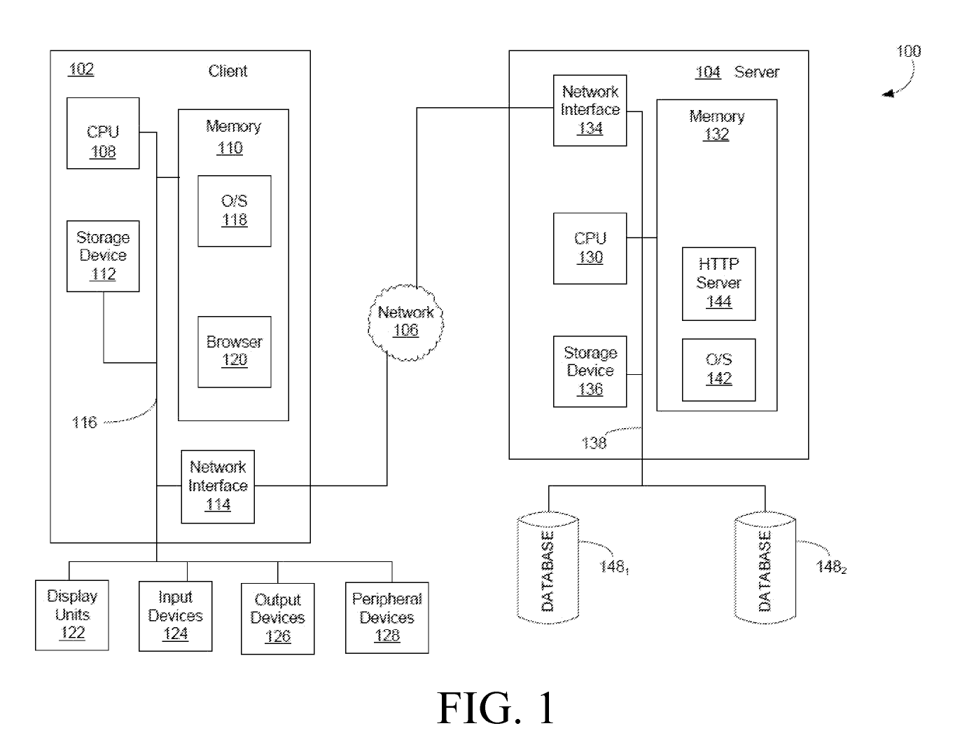

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information conveyed to a computer by a communications medium, such as through a computer or telephone network, including wireless communications. The latter embodiment specifically includes information downloaded from the Internet and/or other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices.

In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

Apparatus, systems, and methods for language learning that may include a new knowledge model and knowledge presentation and may allow in-use reversal of the language assumed known and the language to be learned are described herein.

Turning now to FIG. 1, a block diagram illustrating an exemplary computing environment 100, in accordance with an embodiment of the present invention, is shown. In general, the computing environment 100 includes a client (e.g., a user's) computer 102, and a server computer 104. The client computer 102 and the server computer 104 may be components of the same computer system or may be connected via a network 106, such as the Internet. As shown, the client computer 102 includes a central processing unit (CPU) 108 connected to a memory 110, a storage device 112, and a network interface 114 via a bus 116. The CPU 108 is included to be representative of a single CPU, multiple CPUs, a single CPU having multiple processing cores, and the like. The storage device 112 stores application programs and data for use by the client computer 102. Examples of the storage device 112 include one or more hard-disk drives, flash memory devices, optical media and the like. The client computer 102 may be connected to the data communications network 106 (e.g., a local area network, which itself may be connected to other networks such as the internet) using the network interface 114. The memory 110 can be one or a combination of memory devices, including random access memory, nonvolatile or backup memory (e.g., programmable or flash memories, read-only memories, etc.). Illustratively, the memory 110 of client computer 102 stores an operating system 118 used to manage hardware and software executing on the client computer 102. As shown, memory 110 also includes a browser program 120 which, when executed by CPU 108, provides support for navigating between various servers and locating network addresses at one or more of servers (e.g., server computer 104).

The client computer 102 may be connected to one or more display units 122, input devices 124, output devices 126 and peripheral devices 128. The display units 122 may be internal or external monitors, television screens, handheld device displays, and the like. The input devices 124 may be any one of a keyboard, mouse, track-ball, stylus, mouse pad, mouse button, joystick, scanner or the like. The output devices 126 may be any one of a monitor, printer, plotter, copier or other output device. The peripheral devices 128 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like.

Similar to the client computer 102, the server computer 104 may include a CPU 130, a memory 132, a network interface device 134, and a storage device 136, coupled via a bus 138. The memory 132 may be a random access memory sufficiently large to hold the necessary programming and data structures that are located on the server computer 104. As shown, the memory 132 stores an operating system 140 used to manage server hardware and software executing on the server computer 102. Illustratively, the memory 132 also includes a hypertext transfer protocol (http) server 144 configured to service requests from the client computer 102. For example, the http server 144 may respond to requests for access to electronic resources (e.g., HTML documents, network information, and the like) residing on the server computer 104. However, one of ordinary skill in the art will recognize that the http server 144 is merely illustrative and embodiments of the invention may be adapted to support both known and unknown protocols. The programming and data structures of the http server 144 may be accessed and executed by the CPU 130 as needed during operation. The server computer 104 may connect to the network 106 using the network interface device 134 (e.g., an analog modem, a wired network card, or a wireless network device).

In one embodiment, users may interact with the server computer 104 using a graphical user interface (GUI). In a particular embodiment, GUI content may comprise HTML documents (i.e., web pages) rendered on the display unit 122 coupled with the client computer 102 using the browser 120. In one embodiment, the web pages may include pages that allow a user to play a language-learning game.

The memory 132 may therefore include a language learning system program (not shown). The language learning system program may comprise a software application configured to provide the ability (e.g., via the GUI) for a user to match displayed words in a language the user is learning with words in a language known by the user or pictures displayed in a grid, or vice versa, and to provide hints therefor, keep time and score, modify user settings, etc. The server computer 104 may be coupled to one or more databases 148₁, 148₂ which may include a relational database 148₁ that is queried using an SQL query, or an XML database 148₂ queried using an XML query. The invention, however, is not limited to any particular physical database storage mechanism and may readily be extended to operate on other such mechanisms, whether currently known or unknown. While the databases 148₁, 148₂ are illustrated as being external to the server system, it is noted that the databases 148₁, 148₂ may exist on a local storage device (e.g., storage device 136) of the server computer 104, or may be accessed over the network 106. In some embodiments, the databases may be used to store user account information to allow a user to log in when playing in order to keep track of their language learning progress.

In some embodiments, the language learning system program resides on the client computer 102 memory 110. In such an embodiment, browser 120 is not necessary for the user to play the language learning game. However, the client computer 102 may still connect to server 104 to download updates, additional word sets, which may pertain to additional languages, to transmit high scores, and/or to transmit or receive user information, for example to allow a user to maintain settings and progress when playing the game on various computing devices (home computer, work computer, tablet computer, smartphone, etc.).

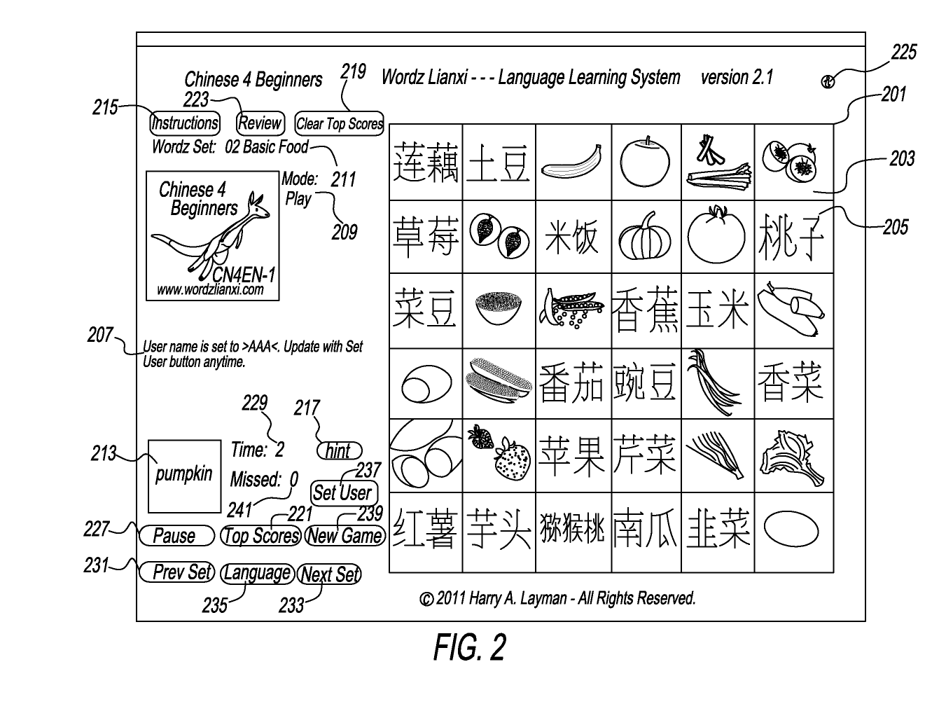

FIGS. 2-14 illustrate various features of a tablet computer embodiment of a language learning system. FIG. 2 shows the opening screen of an English-to-Chinese tablet computer embodiment of the language learning system. The language learning software is installed as an application on tablet computer, utilizing the tablet computer's display. On the screen is grid 201 of tiles 203, 205, each of which contains a word 205 in one of the languages or a picture 203. To the left of the grid is a message area 207, which by default displays the user's user name and instructions for updating the user name. Also to the left of the grid is the mode of use 209, the name of the current set of tiles 211, user controls and matching tile 213, which must be matched to the corresponding tile in grid 201. Here, to indicate the correct answer the user would select the tile with the Chinese characters meaning “pumpkin” or the picture of the pumpkin by touching the corresponding tile on the touch screen.

The user selects (by touching the button on the touch screen) the Instructions button 215 to display the program instructions, Hint button 217 to display a hint for the correct match, Clear Top Scores button 219 to clear the top scores, Top Scores button 221 to view the stored top scores, Review button 223 to change the mode of use from Play to Review, information button 225 to view information about the program, Pause button 227 to stop timer 229, Prev Set or Next Set buttons 231, 233 respectively to change the set 211 of tiles being used, Language button 235 to switch the language of the words in the grid with the language of the words in the matching tiles 213, Set User button 237 to change the user name, or New Game button 239 to randomly select and display a new set of tiles in the grid 201 (from the existing set) and a new matching tile 213. Missed count 241 counts the number of incorrect choices a user has made in the current set so far.

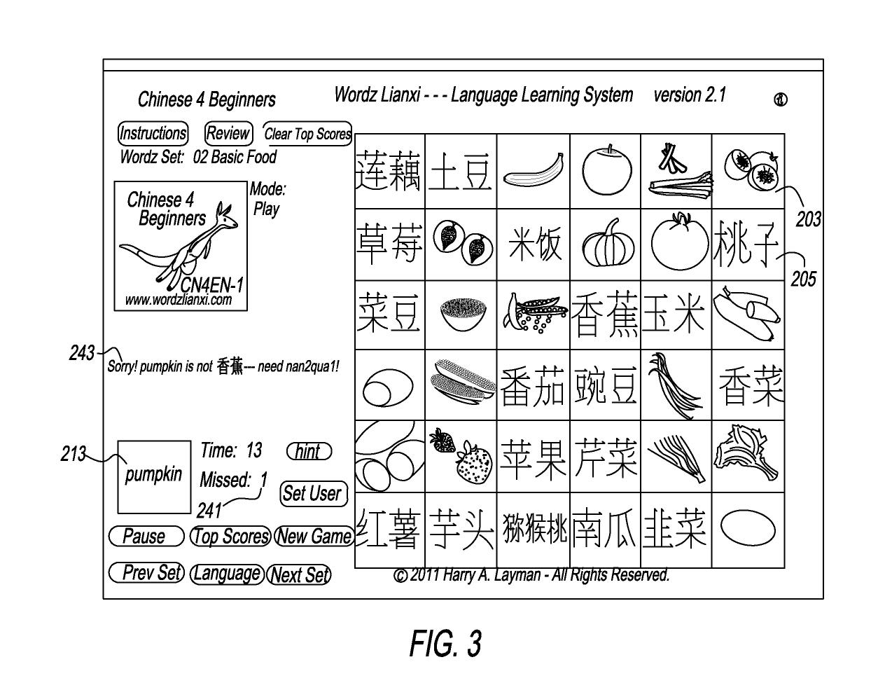

FIG. 3 shows the result when a user selects the wrong tile 203, 205 and not the one that corresponds to the matching tile 213. The missed count 241 is incremented and a message 243 is displayed in message area 207, here “Sorry! Pumpkin is not [Chinese characters]—need nan2qua1!”.

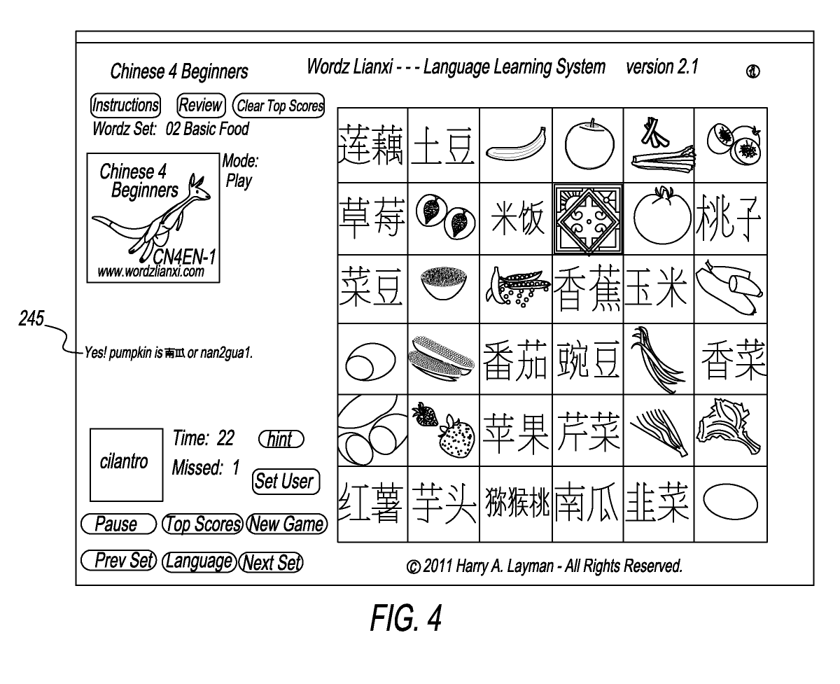

FIG. 4 shows the result when a user selects the correct tile 246. The selected tile 246 is flipped over and a message 245 is displayed, here “Yes! pumpkin is [Chinese characters] or nan2gua1. A new matching tile 213 is displayed.

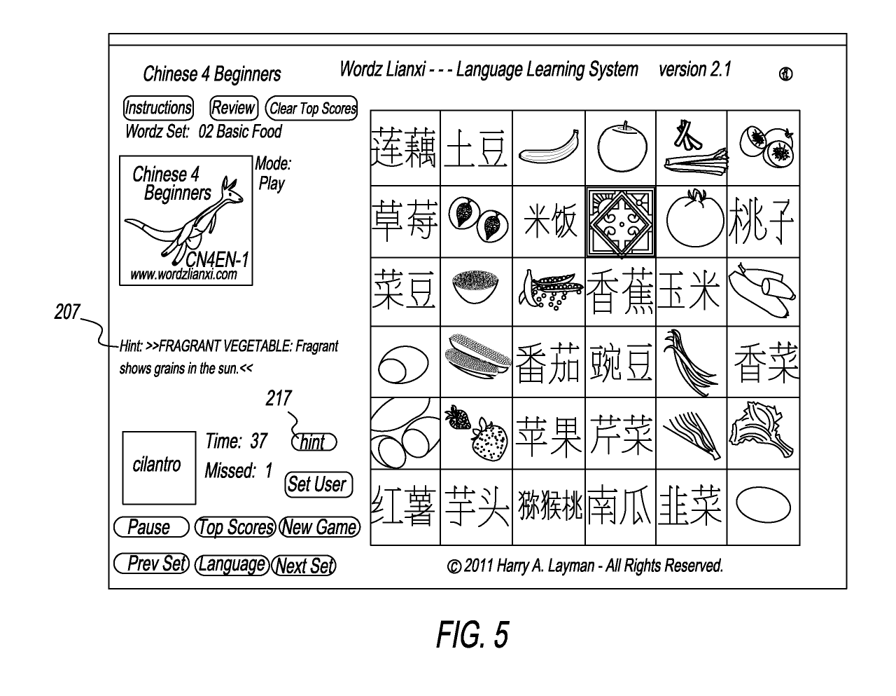

FIG. 5 shows the result when a user selects the Hint button 217. A hint is displayed in the message area 207, here “Hint: >>FRAGRANT VEGETABLE; Fragrant shows grains in the sun<<”. This particular hint indicates the meaning of the individual Chinese characters making up the correct answer and also describes the appearance of one of the characters.

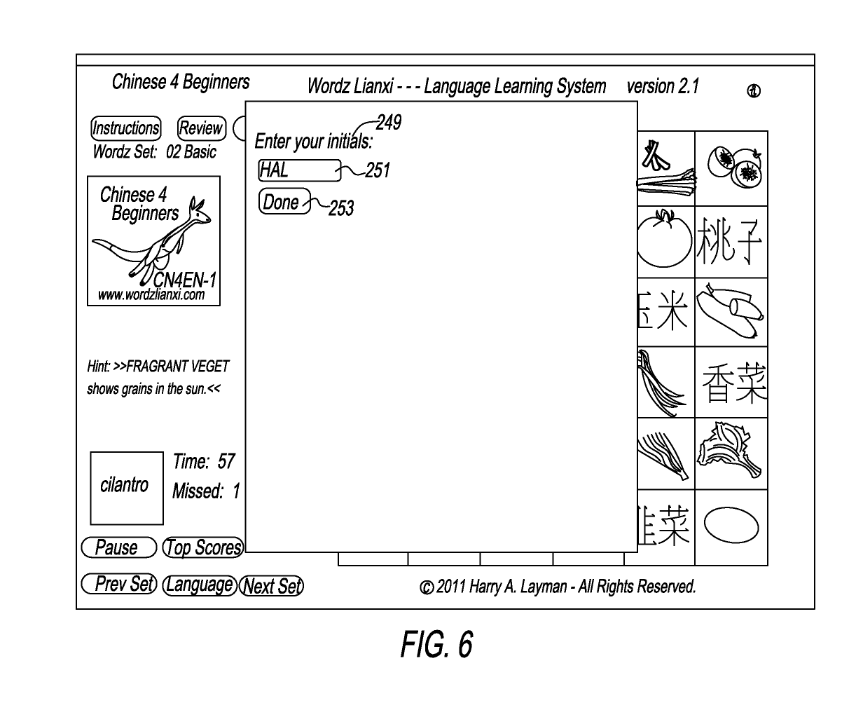

FIG. 6 shows the result when a user selects the Set User button 237. A new screen is displayed with instructions 249 “Enter your initials:”, user name field 251 for entering a user name, and Done button 253 for saving the entered user name and returning to the main screen.

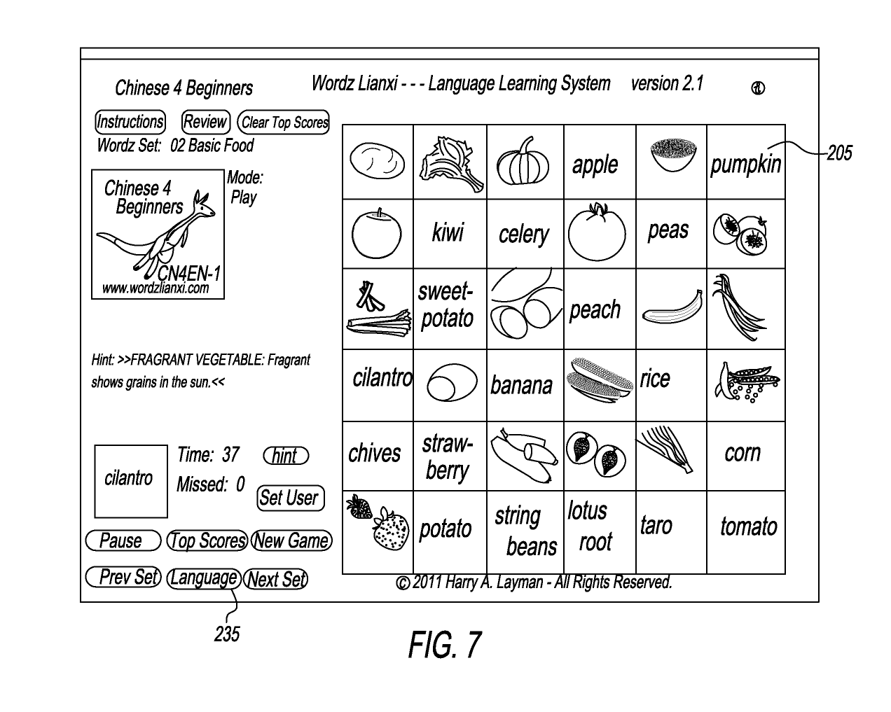

FIG. 7 shows the result when the Language button 235 is selected. The two languages are reversed such that the grid is now populated with English, rather than Chinese, words 205, and Chinese words, rather than English words, now appear as matching tiles.

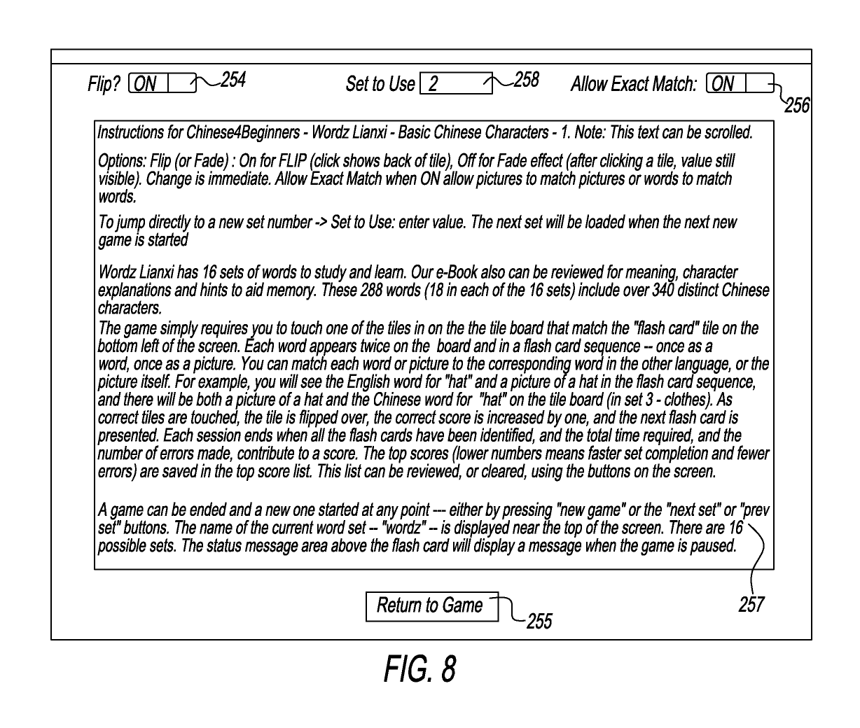

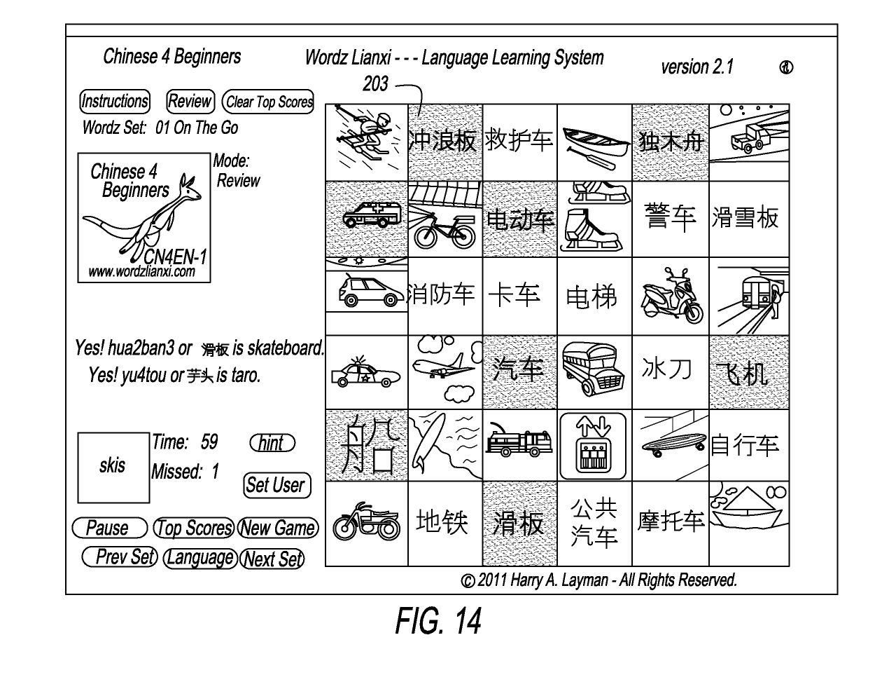

FIG. 8 shows the result when the Instructions button 215 is selected. A new screen appears displaying instructions 257 and Return to Game button 255 for returning to the main screen. At the top, settings 254, 256, 258 appear. Flip setting 254, when set to “On”, makes the cards flip over when selected correctly, as shown in FIG. 4, and when set to “Off”, makes the cards fade out when selected as shown in FIG. 14. Allow Exact Match setting 256 when set to “On”, allows a picture matching tile to be matched to the identical picture in the grid, and when set to “Off” does not allow this. In some embodiments, when tiles are displayed either as tiles to match or as tiles in the grid, both the word and the corresponding picture are displayed as tiles. This will result in two pictures—one corresponding to the English word and one to the Chinese word, for example—that are identical. Choosing to prevent exact matches will disallow matching one picture with the other identical picture. Set to Use setting 258 allows a user to skip directly to a desired set by entering its number, without scrolling through the intermediate sets using the “Prev Set” or “Next Set” button.

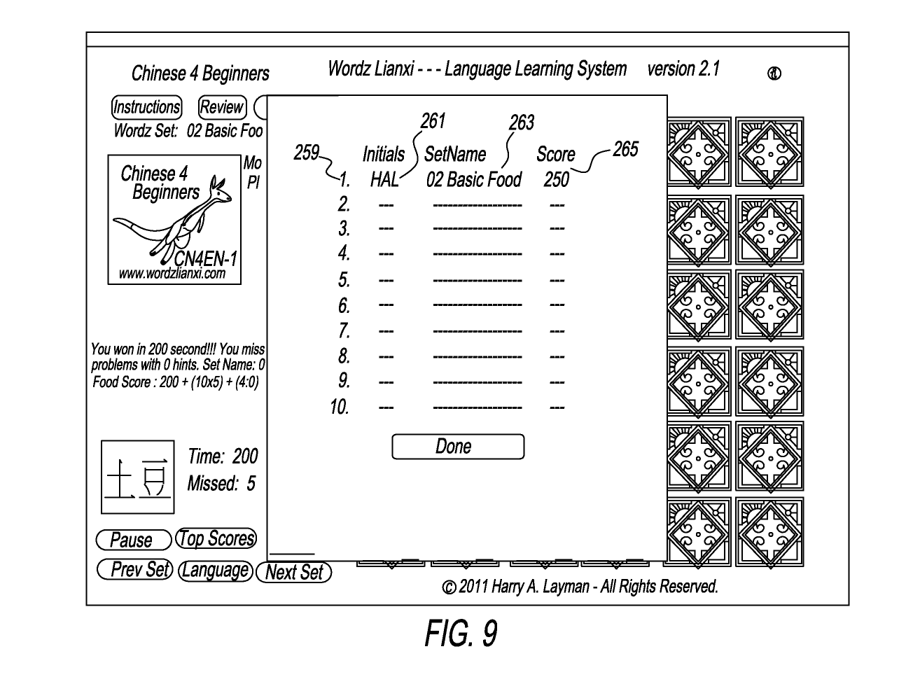

FIG. 9 shows the result when the Top Scores button 221 is selected. A new screen is displayed with a table indicating the highest scores 265 achieved, and the corresponding ranking 259, user name 261, and the name of the set of words 263 it was achieved on.

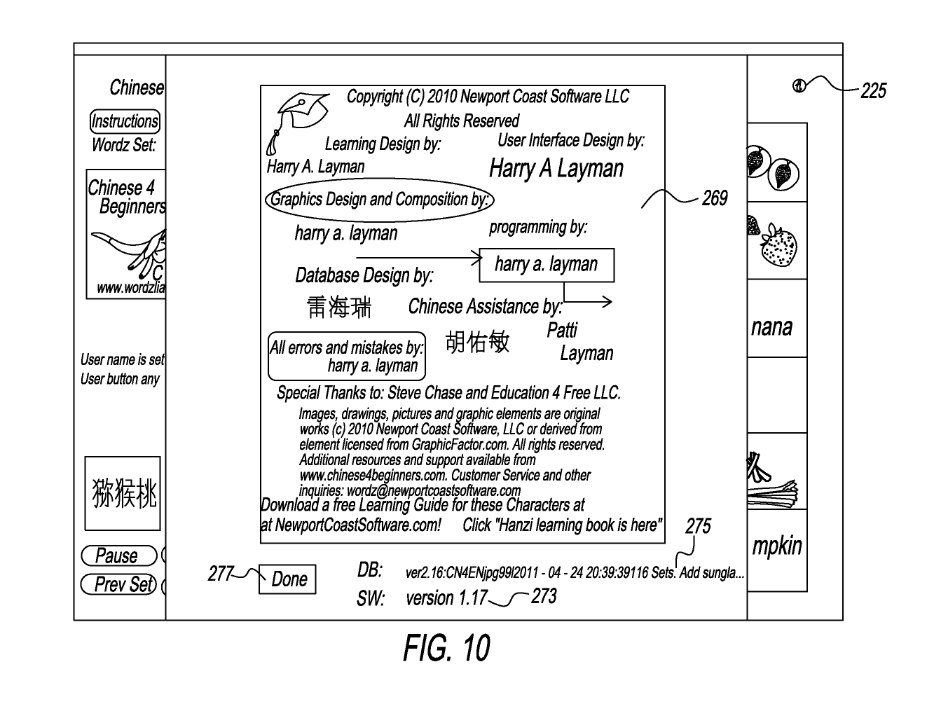

FIG. 10 shows the result when the information button 225 is selected. A new screen is displayed showing information about the program 269, software and database version information 273, 275, and Done button 277.

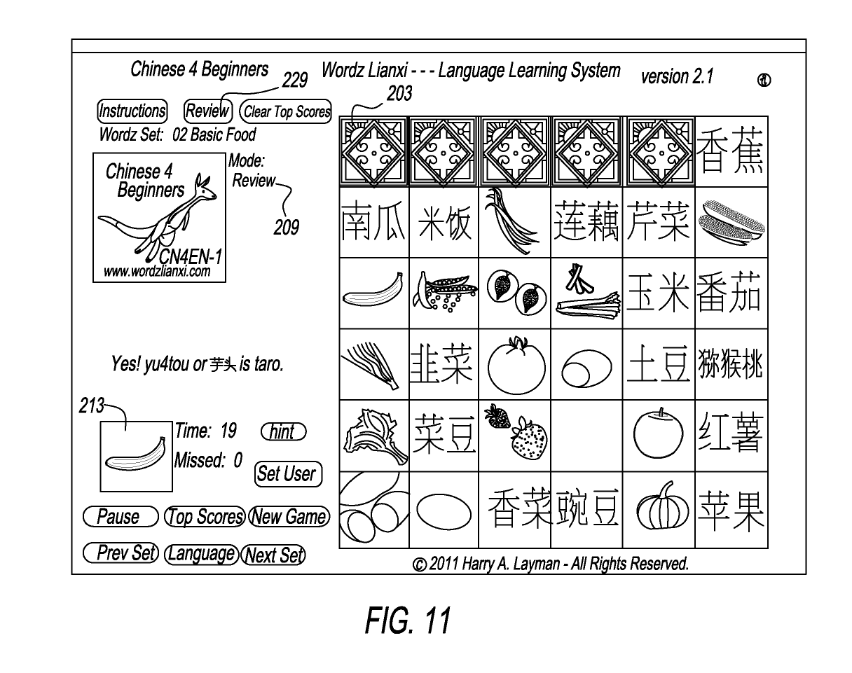

FIG. 11 shows the result when the Review button 279 is selected. The Review button now becomes the Play button and the use mode 209 is changed to Review. In this mode, the matching tiles 213 show up in order on the grid from the top left. So the first matching tile corresponds to the upper left tile 203, the next matching tile will correspond to the tile one to the right, etc. In this mode, initial knowledge is being acquired, not tested.

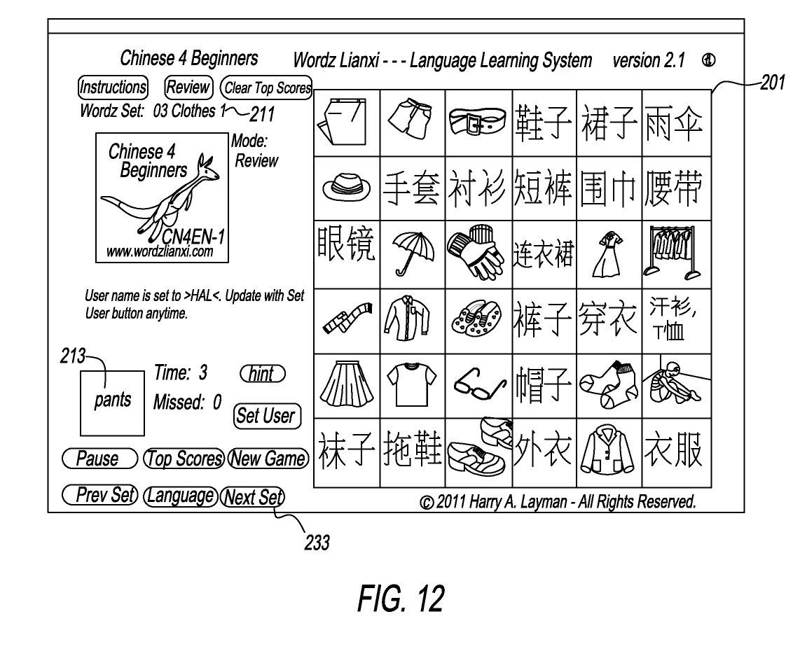

FIG. 12 shows the result when the Next Set arrow 233 is selected. The word set changes, here from “Basic Food” to “Clothes 1”, and a new grid 201 and matching tile 213 are generated.

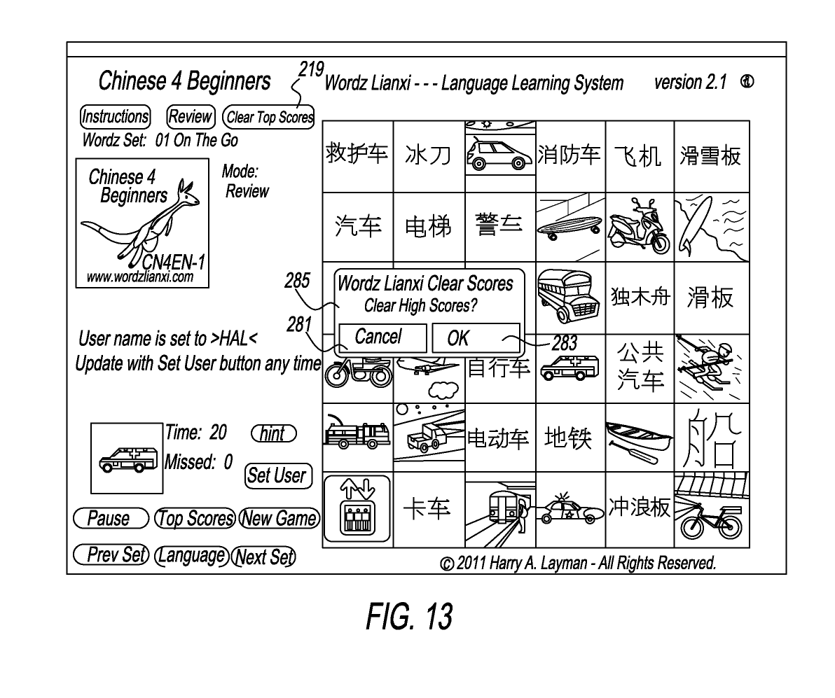

FIG. 13 shows the result when Clear Top Scores button 219 is selected. A pop-up 285 appears with buttons for the user to clear the stored high scores 283 or to cancel the clearing of high scores 281.

In non-tablet computer embodiments, the game interface may be adapted for the different screen shape/size. For example, in a smartphone embodiment Instructions becomes Inst, Clear Top Scores becomes Clear, Set User becomes User, New Game becomes New, Top Scores becomes Top, Language becomes Lang, Prev Set and Next Set become left and right arrows. Additionally, the elements may be rearranged on the display to fir the game elements more closely together, so that their size does not have to be reduced so much as to adversely affect game play. The game can be implemented on any type of computing device, such as a smartphone, desktop or laptop computer, etc. in addition to on a tablet computer.

In various embodiments, additional features not shown above may be included. The game state may be saved when the game is interrupted, with the game state automatically restored on restart. An in-game store API may allow users to buy additional sets of tiles which are downloaded from a server. A notes field may be added to the tiles, with this field made available for editing by a user during the game. The game may include sound files, for example for Chinese phonemes and English words, to demonstrate the correct pronunciation. Sample sentence sound files may also be included.

A new language learning system, method and data structure helps learners or pairs of learners of foreign languages learn to recognize written words in a new language. The method is used to learn words in any language, L1, by speakers of any other language L2—in a manner which can also be used by speakers of language L2 to learn words in language L1. Embodiments utilize a new knowledge model and new knowledge presentation and have the unique ability to reinforce an underlying “knowledge model” for the words and writing system being learned, and a unique ease with which the L1-L2 language elements can be reversed in real time during the learning exercise. The knowledge model, presentation and function are well suited to use on any form of general purpose computing device, including web-based access, desktop computers and particularly on tablet-style computing devices for creating individual learning experiences for students, or pairs of students, of foreign language.

The knowledge model and related hints provide a mechanism for ordering and structuring the underlying knowledge domain so that the learning process can be structured for maximum efficiency, and with associated “hints” allow the learning process to be responsive to the particular knowledge state of the learner. In particular, in some embodiments the knowledge model for words in any language pair represented in the system includes a set of words in language L2 to be learned by a student with knowledge of language L1. This knowledge model further includes, for each word, a) a graphic of the word in the native script of the language to be learned (L2); b) a graphical representation (diagram, picture, abstract drawing, etc.) that can be associated with the L2 word by the learner; c) a closely associated word in the known language (L1) of the learner; and finally, d) zero, one or more components of the word in the L2 language, each with a graphic of the component in native script, a graphic representation, and a corresponding word in the L1 language.

This learning system uses a blended hierarchical relationship (e.g. words and components can be combined in multiple ways, and decomposed into different but valid sets of sub-components) between word components in a language to scaffold, reinforce and rationalize the learning of language L2 for L1 language speakers, and is particularly effective where the L₁ language is an Indo-European language and the user is leaning Sino-Tibetan languages. The hierarchical relationship can be derived from any number of useful techniques, ranging from Knowledge Space theory to visual segmentation and decomposition to imperial data collection from large-scale assessments.

One embodiment of the language learning system was created for English-speaking learners of written Chinese (Hanzi). The learning system lends itself to a visual mechanism for working through knowledge to reinforce recently learned words, add new words in ways that leverage previously learned words, and provide reinforcement as necessary to forgotten words in terms of other previously learned words.

### Learning System:

In some embodiments, the learning systems uses two streams of words or language elements and their associated graphical abstractions, one for language L1 and the other for language L2. For each use, the learner can select from a collection of word groups that have been associated in the knowledge model to reinforce particular language elements. The learner is then presented with two visual representations of the words: a grid of tiles or graphic elements that present a set of words in language L2 and their associated graphical abstractions; and a sequence of the words in language L1 and the same associated graphical abstractions that serve as cues to the L1 speaker to identify the corresponding L2 word in the visual grid. Using a touch screen, the user can either a) select the corresponding L2 word; or b) request a “hint” which will reveal component/composition clues to assist the learner in recognizing the proper L2 word.

In such an embodiment, an incorrect score results in visual and audio feedback; a correct score results in the selected tile being marked as “used” and a new “cue” tile presented to the learner. By selecting all the L2 matches for the L1 words in the set, all the tiles in the L2 tile grid are marked as used and a “score” may be calculated for the learner. The score provides an error-and-hint-and-speed weighted performance indicator which gives the user a way to track progress toward proficiency.

The learning system in some embodiments may include a “review” or learning mode as well, so that the learner can simply review each word in a given word set in turn, seeing the L2 word and abstraction that is associated with each L1 word, with access to the associated “hint”, so that initial exposure to new words can be used to teach the meanings before the user moves into the mode of reinforcement and learning.

The learning system in some embodiments may provide other necessary features, which include the ability to restart a game, ability to navigate to new word sets or repeat word sets being learned, an ability to store and recall the highest level performance on the word sets to provide a record of improved proficiency, and importantly, the ability to switch the L1/L2 language positions in the learning. This supports pairs of students working together, where each student is learning the other's first language, and allows more fluid interactions. It also illustrates the ability to “see” common elements in the words used in the word group in the two languages one after the other in rapid succession. In some languages, this might show the common Greek or Latin roots to related words in a group (say vegetables, or motion verbs) while in other languages it might, for example, show the common character component (strokes) for “vegetables” in the Chinese words for vegetables.

### Knowledge Model:

In some embodiments, the knowledge model may have the following components:

a) Words are grouped into sets to achieve a learning objective. The most common objective in this system when the language is non-alphabetic is to group words together to reinforce common character subcomponents, but other objectives might be to reinforce similar but distinct word features, to compare and contrast word components and associated meanings, and to show words together that are related by usage or meaning that is not apparent from their visual representation.
b) Words are associated with words that are their components, or which they are components of. In addition, words can be associated with other words with common components. These relationships are represented in the “hints” information provided to the learner and visible in the course of the game.
c) Words are associated with a graphical abstraction, as well as with a word or language element in the associated language. A language element is used to indicate a concept that is not represented by a “word” in the other language. An example would be “(suggestion)” in the case where the L1 language is English and the L2 language is Mandarin Chinese—which contains particles indicating “suggestion” (ba5). Additional examples again for the English/Chinese language pair include “(interrogative)” and (“possession”), because Mandarin has a particle (ma1) that makes a declaration into a question or interrogative, and a possessive particle “de5” that indicates a relation of possession between the words on either side of it.

### Details of Knowledge Model: Data Model/Database Design

In some embodiments, a database (such as an XML database) design may include three groups of data or “tables”:

### a) Version Data

A valid set of data for use with the language learning system includes a “version” table which provides technical information to insure that the version of the software and the version of the data are compatible, and to allow, through the user interface, users of the system to know which version of the data specification is relevant for the included word sets and corresponding word tiles.

Information in the Version table may include a last updated date, a comment, and version identifier (e.g. ‘version 2.12 99png’). If the version table contains more than one row, the most recent row (last one retrieved) is considered to have the current and correct values.

Note this data organization allows the number of active sets to change over time—allowing “in game purchase” of more data, or dynamic reconfiguration of the data.

Sample Version Table:

| WordzVID | WordzVNMB | WordzVModifiedDT | WordzVComment |
|---|---|---|---|
| 1 | ver2.16Y: | 2011-06-23 | 16 Sets. CN/ES |
| | ES4CN-F- | 02:07:34 | Set Names. |

(Note: the date item identifier is in the first row and a sample data value is in the second row.)

### b) Set Data

Set data table consists of one or more rows of data, where each row describes a set of word tiles. Each set may have:

SetID—unique identifier. Integer. In other embodiments the SetID may be a string and be used for example as an XML file name.

Set name in language L1—A text string such as “36OnTheGo” or “16FamilyMembers” or “36InTheHouse”.

Set name in language L2

Code for language L1, name of language L1

Code for language L2, name of language L2

Set Status ('A′ for active, ‘I’ for inactive, ‘D’ for in development)

Last modified date

Difficulty level

List of pre-cursor sets (zero, one or more)

An XML schema/DTD may be specified to which all “sets” of data must conform.

Sample Set Data

| | setID | | | | | | |
|---|---|---|---|---|---|---|---|
| | 1 | 2 | 3 | 4 | 5 | 6 | 7 |
| wrodzSetNameL1 | 01 On | 02 Basic | 03 | 04 | 06 Verbs 1 | 08 Queries 1 | 19 |
| | The Go | Food | Clothes 1 | Adjectives 1 | | | Animals |
| wordzSetNameL2 | 01 Los | 02 Los | 03 Las | 04 Los | 06 Los | 08 Las | 19 Los |
| | Transportes | Alimentos | Ropas | Adjetivos 1 | Verbos 1 | Preguntas 1 | Animales |
| | | Basicos 1 | | | | | |
| WordzSetType | PS | PS | PS | PS | PS | PS | PS |
| WordzSetLangL1 | EN | EN | EN | EN | EN | EN | EN |
| wordzSetLangL2 | ES | ES | ES | ES | ES | ES | ES |
| setLangL1Desc | English | English | English | English | English | English | English |
| setLangL2Desc | Spanish | Spanish | Spanish | Spanish | Spanish | Spanish | Spanish |
| setCreateDT | 2010-09-01 | 2010-09-01 | 2010-09-01 | 2010-09-01 | 2010-09-01 | 2010-09-01 | 2010-09-01 |
| setModifiedDT | 2011-06-12 | 2011-06-12 | 2011-06-12 | 2011-06-12 | 2011-06-12 | 2011-06-12 | 2011-06-12 |
| SetStatus | A | A | A | A | A | A | I |

(Note: Sample Data Item Identifier is in the first column and the remaining columns contain possible data values.)

### c) Tile (Word) Data

Each set will have one or more tiles associated with it. Typically a set will have 36 tiles, 18 pairs of corresponding tiles in each of two languages.

This organization specifically supports the re-use of language data across multiple different language pairs and multiple different word sets, and the real-time switch in roles for L1 and L2 during study and learning.

Each tile may have the following properties:

Tile Name—unicode text string, may be the same or similar to word text, e.g. CHUAN2 or BOAT. May be “zou4-a” or “zou4-b” for example to distinguish between Chinese characters with the same pronunciation.

Tile TXT (Unicode, native characters for word) When there are significant common usage alternatives (e.g. bike vs. bicycle, plane vs airplane) this may include more than one word.

Tile Language Code (L1) (e.g. CN for Chinese, EN for English) Each tile represents a single word in a specific language.

TileID (unique for all tiles)

SetID (associates tiles with a single Set)

Matching TileID—tileID for a corresponding tile in this set in language L2

Matching Tile Name—the name of the corresponding tile in this set in language L2, that tile should have the Tile Name of this tile as its Matching Tile Name. Checking that can be part of a set validation process that is run on a set when opened by the game, along with, for example, making sure the set has the correct number of tiles, and that all identified image files can be found.

Tile Word Image file (name of an image file that displays the word in native script)

Tile Pic Image file (name of an image file that displays an abstract representation of the word or concept) (note: two matching tiles will have the same Pic Image file name)

Hint information

Last Modified Date

Reference Text—special field tying this word to an outside source. Example: “TLCC-231”.

Field can be blank.

Example Sentence—Unicode text containing the word used in a sample sentence in it's language.

Usage examples

Difficulty level

A sample of key Word Tile data attributes for 10 tiles is presented below.

| | | tile | | | | matching | | |
|---|---|---|---|---|---|---|---|---|
| tileID | setID | LangID | tileNM | tileTXT | matchingTileNM | TileIDX | tileWordPicImageNM | tileWordWordImageNM |
| 0 | 1 | CN | chuan2 | [symbol] | lebateau | 20005 | boat_chuan2_pic100.jpg | chuan2_word100.jpg |
| 1 | 1 | CN | che1 | [symbol] | lavoiture | 20006 | car_che1_pic100.jpg | qi4che1_word100.jpg |
| 2 | 1 | CN | ka3che1 | [symbol] | lecamion | 20007 | truck_ka3che1_pic100.jpg | ka3che1_word100.jpg |
| 3 | 1 | CN | fei1ji1 | [symbol] | lavion | 20008 | plane_fei1ji1_pic100.jpg | fei1ji1_word100.jpg |
| 4 | 1 | CN | zi4xing2che1 | [symbol] | labicyclette | 20009 | bike_zi4xing2che1_pic100.jpg | zi4xing2che1_word100.jpg |
| 20005 | 1 | FR | lebateau | le bateau | chuan2 | 0 | boat_chuan2_pic100.jpg | le_bateau_word100.png |
| 20006 | 1 | FR | lavoiture | la voiture | che1 | 1 | car_che1_pic100.jpg | la_voiture_word100.png |
| 20007 | 1 | FR | lecamion | le camion | ka3che1 | 2 | truck_ka3che1_pic100.jpg | le_camion_word100.png |
| 20008 | 1 | FR | lavion | l'avion | fei1ji1 | 3 | plane_fei1ji1_pic100.jpg | l_avion_word100.png |
| 20009 | 1 | FR | labicyclette | la bicyclette | zi4xing2che1 | 4 | bike_zi4xing2che1_pic100.jpg | la_bicyclette_word100.png |

### Additional User Controls:

Additional user controls may include one to enable “sound” and another labeled “Test Set”. The sound button allows learners to hear the sound associated with the next word selected; the “Test Set” button generates a random set of tiles for the tile board from all the active sets included with a particular product.

In some embodiments, the language learning system includes a game played by one to three players, who take turns using an internet browser or an iPad/slate/device to play the game either through a browser working against a remote server or entirely on the handheld device. In some embodiments, each player can use a different means of accessing the game (smartphone, computer, etc.), with the players linked through a server. In some embodiments the game is provided in both browser and smartphone/ipad formats and share the same data collections (XML files and associated graphics) for the “set” (or “set of tiles”) that provide the words and picture elements.

### I. Environment/Community Infrastructure/Application Overview

In some embodiments, the game is constructed within the context of a community website.

A community website may include modules for self-registration via email. On the web community, one or more sample instances of the game may be available for ‘unregistered’ players, who can play only the one or more “sets” of tiles, in practice mode (e.g. 1 player) or multi-player mode (competitive mode, 2 or 3 players).

The web community infrastructure may leverage a framework providing for self registration/signup and capture of simple demographic information and allowing for the addition of paid “membership”, creating higher levels of service for participants.

Users of the site may have the following roles:

Administrators, who can terminate or adjust user status, and contribute content and edit other aspects of the site

Visitors that are unregistered and may play the game using a pre-defined unregistered player “set” of data

Members, who can play all “free” word sets. When members play in “practice” (single player) mode, the sets they have played, and the best score attained while playing each set, is retained.
Learners, who may pay some fee and have access to additional, fee-only word sets, and other site features.

The invention is not limited to the particular embodiments described above in detail. Those skilled in the art will recognize that other arrangements could be devised, for example, using various GUIs, which may for example be customized for various computing devices, and various buttons and settings for navigating and customizing the GUIs. While the invention has been described with reference to specific illustrative embodiments, modifications and variations of the invention may be constructed without departing from the scope of the invention.

I claim:

1. A system, comprising:
a processor; and
a memory containing a program, which, when executed by the processor, is configured to perform an operation, the operation comprising:
displaying a first half of a set of tiles, the first half comprising words in a first language and pictures representing the words in the first language;
indicating a tile to be matched, wherein the tile to be matched is selected from a second half of the set of tiles, the second half comprising words in a second language and pictures representing the words in the second language, wherein each tile in the first half of the set corresponds to a tile in the second half of the set;
displaying user options;
receiving user input; and
determining whether the user input selected a tile from the first set of tiles and if so whether the selected tile corresponds to the tile to be matched and displaying an indication of whether the selection corresponds accordingly, and when the selected tile corresponds to the tile to be matched, indicating another tile from the second half of the set of tiles as the tile to be matched.

2. The system of claim 1, wherein the operation further comprises displaying an indication that the selected tile has been matched when the selected tile corresponds to the tile to be matched.

3. The system of claim 1, wherein the words in the set of tiles are conceptually related.

4. The system of claim 3, wherein two or more words in at least one of the first half and the second half of the set of tiles share Sino-Tibetan characters.

5. The system of claim 1, wherein the operation further comprises replacing the set of tiles from which the displayed tiles are drawn with a second set of tiles, in response to the user input.

6. The system of claim 1, wherein the operation further comprises swapping the first half of the set of tiles and the second half of the set of tiles in response to the user input, such that the second half of the set of tiles is displayed and a first tile from the second half of the set of tiles is displayed, whereby the positions of the first and second languages are reversed in the system.

7. The system of claim 1, wherein the operation further comprises changing the language of displayed instruction text and labels from one language to another in response to the user input.

8. The system of claim 1, wherein the operation further comprises providing a hint as to the correct match for the tile to be matched in response to the user input.

9. The system of claim 1, wherein the operation further comprises calculating a score taking into account one or more factors selected from the following group: time spent, incorrect guesses, and number of hints.

10. The system of claim 1, wherein the displaying of the first half of the set of tiles comprises displaying the first half of the set of tiles in a random order that is independent of the order in which the second half of the set of tiles is displayed.

11. The system of claim 1, wherein the displaying of the first half of the set of tiles comprises displaying the first half of the set of tiles in the same order as the second half of the set of tiles is indicated.

12. The system of claim 1, wherein the displaying of the first half of the set of tiles comprises displaying the first half of the set of tiles in a grid pattern.

13. The system of claim 1, wherein the operation further comprises receiving payment information and downloading a new set of tiles in response to the user input.

14. The system of claim 1, wherein the operation further comprises receiving login information and allowing access to sets of tiles accordingly.

15. A method, comprising:
displaying on a display device a first half of a set of tiles, the first half comprising words in a first language and pictures representing the words in the first language;
indicating on the display device a tile to be matched from a second half of the set of tiles, the second half comprising words in a second language and pictures representing the words in the second language, wherein each tile in the first half of the set corresponds to a tile in the second half of the set;
displaying on the display device user options;
receiving user input via an input device; and
determining, using a processor, whether the user input selected a tile from the first set of tiles that corresponds or does not correspond to the tile to be matched and displaying on the display device an indication of the selection accordingly, and when the selected tile corresponds to the tile to be matched, indicating on the display device as the tile to be matched another tile from the second half of the set of tiles.

16. The system of claim 15, further comprising displaying an indication that the selected tile has been matched when the selected tile corresponds to the tile to be matched.

17. The system of claim 15, wherein two or more words in at least one of the first half and the second half of the set of tiles share Sino-Tibetan characters.

18. The system of claim 15, further comprising replacing the set of tiles from which the displayed tiles are drawn with a second set of tiles, in response to the user input.

19. The system of claim 15, further comprising swapping the first half of the set of tiles and the second half of the set of tiles in response to the user input, such that the second half of the set of tiles is displayed and a tile to be matched from the second half of the set of tiles is indicated.

20. A computer-readable storage medium including a program, which when executed on a processor performs an operation, the operation comprising:
displaying a first half of a set of tiles, the first half comprising words in a first language and pictures representing the words in the first language;
indicating a tile to be matched from a second half of the set of tiles, the second half comprising words in a second language and pictures representing the words in the second language, wherein each tile in the first half of the set corresponds to a tile in the second half of the set;
displaying user options;
receiving user input; and
determining whether the user input selected a tile from the first set of tiles that corresponds or does not correspond to the tile to be matched and displaying an indication of the selection accordingly, and if the selected tile corresponds to the tile to be matched, indicating as the tile to be matched a second tile from the second half of the set of tiles.
